(19) United States
(12) Patent Application Publication
(10) Pub. No.: US 2010/0023145 A1
(43) Pub. Date: Jan. 28, 2010

(54) Content outputting device, content outputting method, and program

(75) Inventor: Masanari Yagura, Tokyo (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/460,230

(22) Filed: Jul. 15, 2009

(30) Foreign Application Priority Data
Jul. 18, 2008 (JP) P2008-187425

(51) Int. Cl. G06F 17/00

(52) U.S. Cl. 700/94

(57) ABSTRACT

A content outputting device includes: a connecting section used for connection with another device; a storing section configured to store, in association with the connecting section, a setting value used for setting for outputting of content to be supplied from the another device connected via the connecting section; and a setting section configured to perform, during start of the outputting of the content supplied from the another device, the setting for the outputting of the content, on the basis of the setting value stored by the storing section.

### CROSS-REFERENCE TO RELATED APPLICATION

The present application claims priority from Japanese Patent Application JP 2008-187425 filed in the Japanese Patent Office on Jul. 18, 2008, the entire content of which is incorporated herein by reference.

### BACKGROUND OF THE INVENTION

1. Field of the Invention

The present invention relates to content outputting devices, content outputting methods, and programs. In particular, the present invention relates to a content outputting device, a content outputting method, and a program which are capable of reducing the amount of time taken until outputting of content is started.

2. Description of the Related Art

In recent years, an HDMI (high-definition multimedia interface) standard has been available as an interface standard for interconnecting the so-called “digital home electronic equipment”, such as a digital television receiver, a digital video camera, a digital video recorder, a digital player, a digital tuner, and a home-use game machine. HDMI devices equipped with terminals that comply with the HDMI standard are increasingly used.

Hereinafter, of HDMI devices equipped with terminals that comply with the HDMI standard, HDMI devices, such as a DVD (digital versatile disc) player, that supply content such as video and sound are referred to as “source devices”. An HDMI device, such as a television receiver, that outputs content supplied from a source device is referred to as a “sink device”.

Control signals for performing device authentication, various settings, and so on are transmitted/received between a source device and a sink device. For example, by using an HPD (hot-plug detect) signal, the sink device notifies the source device that EDID (Extended Display Identification Data) including information, such as a maximum resolution and a color characteristic of a display, can be read and the sink device is compliant with HDCP (High-bandwidth Digital Content Protection) authentication processing, which is one copyright protection technology.

In general, when multiple source devices are connected to a sink device via HDMI terminals, a source device selected (specified) so as to supply content to the sink device is in a selected state and a source device that is not selected so as to supply content is in a non-selected state. The sink device performs control for causing the HPD signal for the HDMI terminal to which the source device in the selected state to change to high and for causing the HPD signal for the HDMI terminal to which the source device in the non-selected state to change to low.

Some sink devices are also equipped with a CEC (consumer electronics control) function for mutually controlling devices. Such a sink device typically needs to maintain the HPD signals for all HDMI terminals high so as to be able to read the EDID of the source device in the non-selected state anytime. When the source device is changed in accordance with a user operation or the like, the sink device performs control (a toggle operation) for changing the HPD signal for the HDMI terminal to which the source device to be newly put into the selected state to low for a predetermined period of time to perform standby and then changing the HPD signal to high again.

When the sink device performs such an HPD-signal toggle operation, the source device responds to the toggle operation and performs HDCP authentication processing again to perform processing (resetting) for resuming from an HDCP error state.

After the resetting, the source device transmits a data signal containing, for example, resolution information, color-space information, and sound information to the sink device. On the basis of various types of information contained in the data signal, the sink device performs setting so as to allow appropriate outputting of content, and then starts outputting of the content. The sink deice performs setting for, for example, horizontal and vertical synchronization signal frequencies, TMDS (transition minimized differential signaling) clock frequencies, interlace/progressive system, color space, colorimetry, DeepColor, PCM (pulse code modulation)/compression audio, and sampling frequency.

However, depending on the source device, the timing of transmission of content data and the timing of transmission of information data may not match each other. Thus, when the sink device outputs content data with setting that faithfully complies with the information data, the image and sound quality declines, such as image distortion and sound interruption, may occur.

Thus, for example, in input switching processing in which the source device that is to input content to the sink device is changed, after performing standby until the data signal transmitted from the source device becomes stable, the sink device performs setting for outputting on the basis of the data signal and then starts the outputting of the content.

Input switching processing performed by a typical sink device will now be described with reference to FIG. 1.

For example, when the user specifies a desired HDMI terminal so as to switch a source device that is to input content to a sink device, the input switching processing is started. In step S11, the sink device performs input switching so that content supplied via the HDMI terminal specified by the user is output and also performs muting of outputting of the content (e.g., performs setting for causing a black image to be displayed on a display and for stopping outputting from a speaker).

After the processing in step S11, the process proceeds to step S12 in which the sink device switches the HPD signal for the user-specified HDMI terminal from high to low. The process then proceeds to step S13. In step S13, the sink device causes the processing to stand by from when the HPD signal is switched to low in step S12 until a low period stored in association with a user-specified HDMI terminal (e.g., a period of time set so as to correspond to a source device determined to have a worst condition on the basis of past data) passes. When the low period passes, the process proceeds to step S14 in which the sink device switches the HPD signal for the HDMI terminal from low to high.

After the processing in step S14, the process proceeds to step S15 in which the sink device sets a predetermined parameter n to 0 as an initial value. The process then proceeds to step S16 in which the sink device obtains a data signal transmitted from the source device. The source device periodically transmits the data signal at predetermined intervals.

After the processing in step S16, the process proceeds to step S17 in which the sink device determines whether or not the parameter n is smaller than N, which is preset as the number of operations for obtaining the data signal from the source device. For example, N indicates the number of operations performed until it is determined based on past data that the data signal becomes stable.

When it is determined in step S17 that the parameter n is smaller than N, the process proceeds to step S18 in which the sink device increments the parameter n by 1. The process then proceeds to step S19.

In step S19, the sink device stands by for an amount of time corresponding to a time T2. The time T2 is a system-dependent time that is determined considering the hardware limitation of the sink device and a signal frequency. When the time T2 passes, the process returns to step S16. That is, the processing for obtaining the data signal each time the time T2 passes is repeated until it is determined in step S17 that the parameter n is not smaller than N (i.e., is equal to N), that is, until the sink device receives the data signal N times.

On the other hand, when it is determined in step S17 that the parameter n is not smaller than N, the process proceeds to step S20 in which the sink device determines whether or not the data signal transmitted from the source device is stable. For example, when all the data signals received through the N obtaining operations have the same contents, the sink device determines that the data signal transmitted from the source device is stable, and when the contents of even one of the data signals received through the N obtaining operations is different from the contents of another data signal, the sink device determines that the data signal is not stable.

When it is determined in step S20 that the data signal transmitted from the source device is not stable, the process returns to step S15 and then processing as described above is repeated until it is determined that data signal transmitted from the source device is stable. When it is determined in step S20 that the data signal transmitted from the source device is stable, the process proceeds to step S21.

In step S21, the sink device reads setting values of resolution information, color-space information, and sound information from the data signal and stores the setting values. In step S22, on the basis of the setting values, the sink device performs setting for outputting of the content.

In step S23, the sink device releases the muting of the outputting of the content and starts the outputting of the content in accordance with data of the content transmitted from the source device, thereby ending the input switching processing.

As described above, in the input switching processing, the sink device causes the processing to stand by until the data signal transmitted from the source device becomes stable. Thereafter, after performing setting based on the stable data signal, the sink device starts the outputting of the content.

As technologies related to such an HDMI device, for example, Japanese Unexamined Patent Application Publication No. 2008-35060 discloses a technology for detecting a connection between HDMI devices by using a hot-plug detection scheme and Japanese Unexamined Patent Application Publication No. 2007-158903 discloses a technology that can change a resolution through an operation at a sink device. In addition, Japanese Unexamined Patent Application Publication No. 2007-288407 discloses a technology for preventing a video abnormality from being displayed on a sink device when a signal output from a source device temporarily enters an irregular signal state.

### SUMMARY OF THE INVENTION

As described above, since the sink device of the related art causes the processing to stand by until the data signal transmitted from the source device becomes stable, the amount of time from when the user performs an input switching operation until outputting of content is started may increase. Thus, the user may feel that a response to the operation is slow. Thus, there is a request for a sink device that reduces the amount of time taken until outputting of content is started and that quickly responds to an operation.

In view of the foregoing situation, it is desirable to make it possible to reduce the amount of time taken until outputting of content is started.

According to one embodiment of the present invention, there is provided a content outputting device. The content outputting device includes: connecting means used for connection with another device; storing means for storing, in association with the connecting means, a setting value used for setting for outputting of content to be supplied from the another device connected via the connecting means; and setting means for performing, during start of the outputting of the content supplied from the another device, the setting for the outputting of the content, on the basis of the setting value stored by the storing means.

According to another embodiment of the present invention, there is provided a content outputting method for a content outputting device for outputting content. The content outputting device has connecting means used for connection with another device and storing means for storing, in association with the connecting means, a setting value used for setting for outputting of content to be supplied from the another device connected via the connecting means. The content outputting method includes a step of causing the content outputting device to perform, during start of the outputting of the content supplied from the another device connected via the connecting means, the setting for the outputting of the content, on the basis of the setting value stored by the storing means.

According to another embodiment of the present invention, there is provided a program for a computer for a content outputting device for outputting content. The content outputting device has connecting means used for connection with another device and storing means for storing, in association with the connecting means, a setting value used for setting for outputting of content to be supplied from the another device connected via the connecting means. The program causes the computer to function as setting means for performing, during start of the outputting of the content supplied from the another device connected via the connecting means, the setting for the outputting of the content, on the basis of the setting value stored by the storing means.

According to the embodiment of the present invention, during start of outputting of content supplied from the another device connected via the connecting means, setting for the outputting of the content is performed on the basis of the setting value stored by the storing means in association with the connecting means, the setting value being used for performing the setting for the outputting of the content supplied from the another device connected via the connecting means.

According to the present embodiment, it is possible to reduce the time taken until outputting of content is started.

### BRIEF DESCRIPTION OF THE DRAWINGS

FIG. 1 is a flowchart illustrating input switching processing performed by a sink device of related art;

FIG. 2 is a block diagram showing an example of the configuration of a sink device according to an embodiment of the present invention;

FIGS. 3A to 3C are diagrams showing plugging/unplugging of an HDMI cable that connects the sink device and a source device;

FIG. 4 is a diagram showing the configuration of signal lines of the HDMI cable;

FIG. 5 shows an example of a change in an HPD signal;

FIG. 6 is a flowchart illustrating low-period optimization processing;

FIG. 7 is a flowchart illustrating input switching processing;

FIG. 8 is a flowchart illustrating setting-value obtaining processing; and

FIG. 9 is a flowchart illustrating release optimization processing for optimizing timing for releasing muting.

### DESCRIPTION OF THE PREFERRED EMBODIMENTS

A specific embodiment of the present invention will now be described in detail with reference to the accompanying drawings.

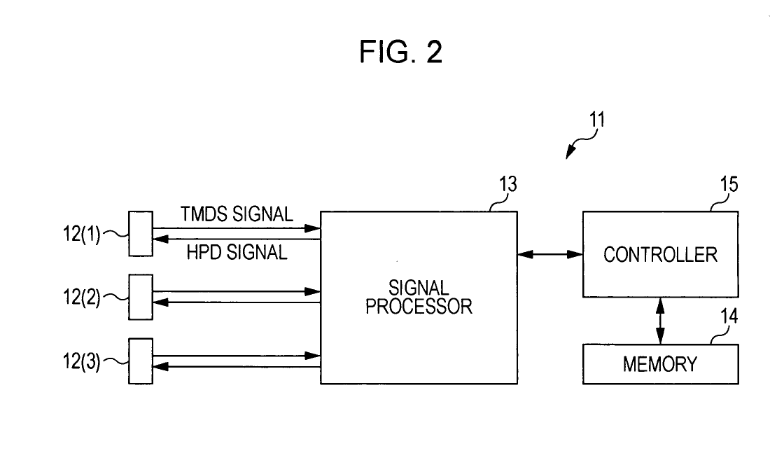

FIG. 2 is a block diagram showing an example of the configuration of a sink device according to one embodiment of the present invention.

In FIG. 2, a sink device 11 includes three HDMI terminals 12(1) to 12(3), a signal processor 13, a memory 14, and a controller 15.

The HDMI terminals 12(1) to 12(3) serve as connecting means that comply with an HDMI standard. Source devices (not shown) are connected to the sink device 11 through corresponding HDMI cables (not shown).

Under the control of the controller 15, the signal processor 13 processes signals transmitted to or received from the source devices connected to the HDMI terminal 12(1) to 12(3). For example, a TDMS (transition minimized differential signaling) signal that conveys data of content is transmitted from the source device(s) to the signal processor 13. In response to the TMDS signal, the signal processor 13 supplies the TDMS signal to subsequent circuits (not shown), such as a decoding circuit and a display circuit. The signal processor 13 performs control for switching between the high and low of a control signal to be output to each of the source devices via the HDMI terminal 12(1) to 12(3).

The signal processor 13 has a switching function. Thus, the signal processor 13 performs input switching so that an arbitrary one of the source devices connected via the HDMI 12(1) to 12(3) supplies content to the sink device 11. That is, since the signal processor 13 has the switching function, the sink device 11 can be equipped with the multiple HDMI terminals 12(1) to 12(3).

The memory 14 may be implemented by, for example, a nonvolatile flash memory (e.g., an EEPROM [Electronically Erasable and Programmable Read Only Memory]) that is readable/writable under the control of the controller 15. The memory 14 stores, for example, a program to be executed by the controller 15 and data used for processing performed by the controller 15.

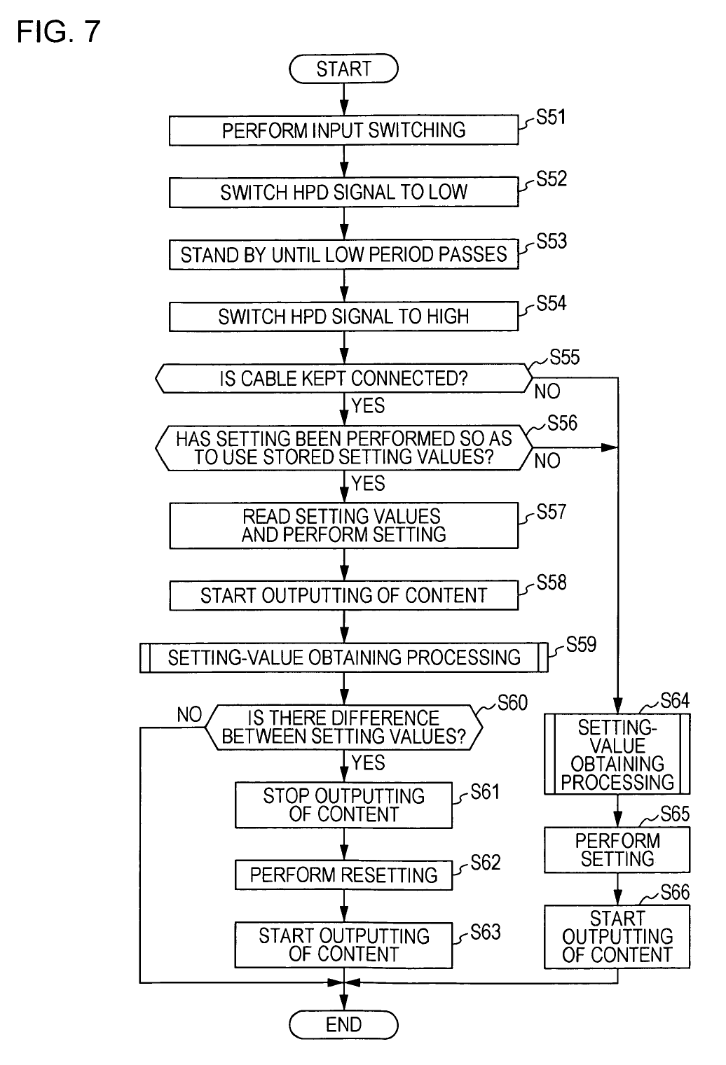

The memory 14 also stores, for each of the HDMI terminals 12(1) to 12(3), information indicating a standby period in which an HPD (hot-plug detect) signal is set to low in input switching processing (described below and shown in FIG. 7) in which the source device that is to input content to the sink device 11 is changed. The information indicating the standby period is referred to as a “low period T_LOW of the HPD signal”. That is, the memory 14 stores low periods T_LOW(1) to T_LOW(3) of the HPD signals in association with the corresponding HDMI terminals 12(1) to 12(3).

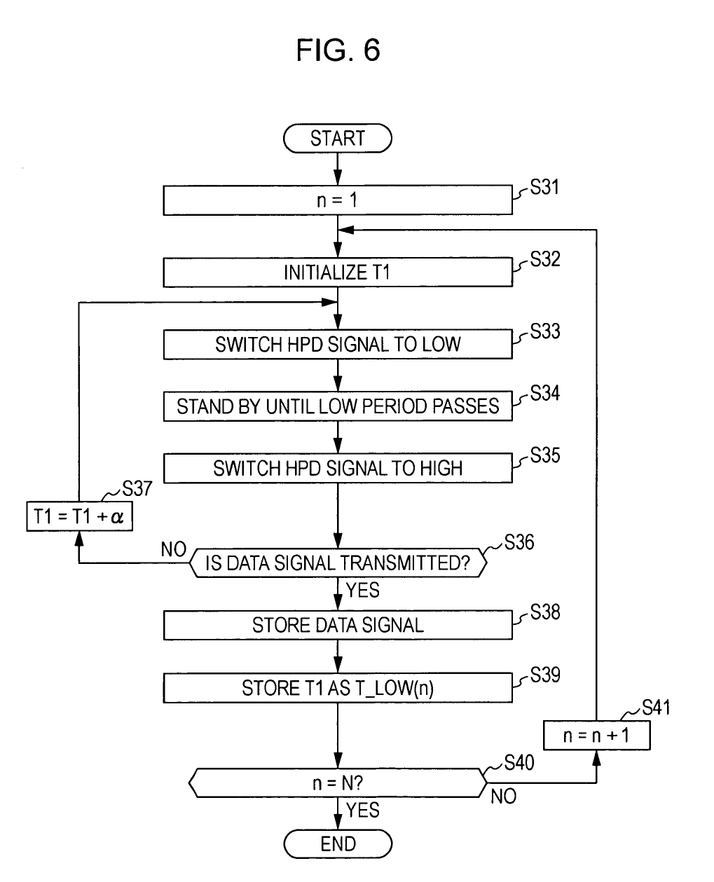

The memory 14 also stores an initial value t (init) of the low period T_LOW of the HPD signal. The initial value t (init) is used in an initial state before low-period optimization processing (processing described below and shown in FIG. 6) in which the low period T_LOW of the HPD signal is optimized for each HDMI terminal. The initial value t (init) is set to, for example, 100 ms, which is a period of time set by the HDMI standard as a period in which the source device should detect the low state of the HPD signal and make a response.

In addition, in the low-period optimization processing, the optimized low period T_LOW of the HPD signal is obtained and also setting values used for setting for outputting of content supplied from the source device connected to each HDMI terminal are obtained. The memory 14 stores the setting values in association with each of the HDMI terminals 12(1) to 12(3).

The controller 15 has therein, for example, a CPU (central processing unit), a ROM (read only memory), and a RAM (random access memory). In the controller 15, the CPU performs processing for controlling the elements in the sink device 11 by executing a program stored in the ROM or by executing a program read from the memory 14 and loaded to the RAM.

For example, the controller 15 monitors a change in the HPD signal to be output via the signal processor 13, detects the plugging/unplugging of each HDMI cable, which connects the source device to the sink device 11, on the basis of the change in the HPD signal, and performs processing based on a result of the detection. It is assumed that, for example, during replacement of the source device connected to the sink device 11, the user unplugs the HDMI cable connected to the HDMI terminal 12. In this case, the controller 15 detects the unplugging of the HDMI cable and stores the information indicating the unplugging. Thereafter, when content is to be supplied from a source device via the that HDMI terminal 12, the controller 15 performs processing for resetting the setting values and so on stored in the memory 14 and re-obtaining setting values.

When the controller 15 has not detected unplugging of the HDMI cable, that is, when the HDMI cable is kept connected to the source device, the controller 15 uses the setting values stored in the memory 14 to perform setting for outputting content. For example, in general, in a normal use state of the HDMI devices, the sink device 11 and the source device are used while being connected through the HDMI cable and without change of the format of signals for conveying content. In such a use state, performing setting using the setting values stored in the memory 14 (i.e., the setting values that have been previously set) makes it possible to reduce the amount of time taken until outputting of the content is started, compared to a case in which each time content from the source device is input, processing stands by until data information transmitted from the source device becomes definite and setting for outputting of the content is performed based on the data information.

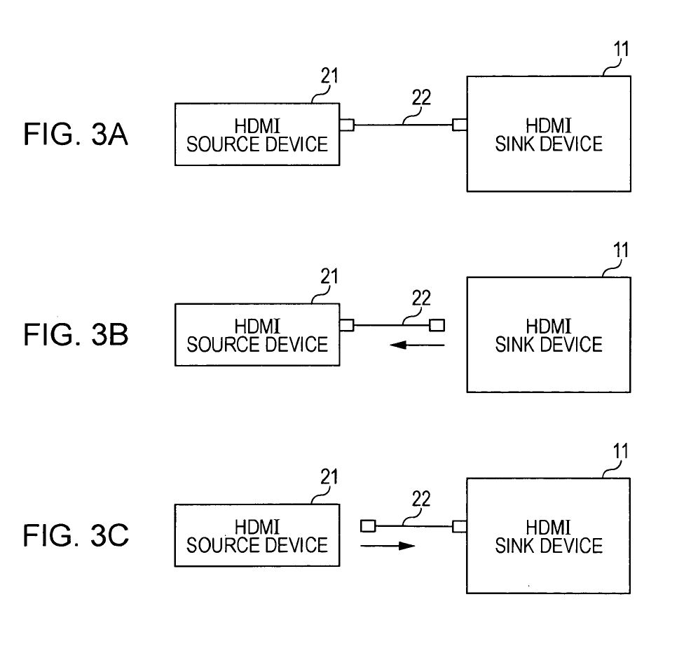

FIGS. 3A to 3C are diagrams showing plugging/unplugging of the HDMI cable that connects the sink device 11 and the source device.

FIG. 3A shows a state in which an HDMI cable 22 is plugged into both the sink device 11 and a source device 21. FIG. 3B shows a state in which the HDMI cable 22 is unplugged from the sink device 11, and FIG. 3C shows a state in which the HDMI cable 22 is unplugged from the source device 21.

For example, when the state (FIG. 3A) in which the HDMI cable 22 is plugged into both the sink device 11 and the source device 21 changes to the state (FIG. 3B or 3C) in which the HDMI cable 22 is unplugged from one of the sink device 11 and the source 21, the controller 15 detects the unplugging of the HDMI cable 22. When the HDMI cable 22 is thus unplugged, there is a possibility that the source device 11 that has been connected to the sink device 11 is changed. Thus, the controller 15 causes information indicating the unplugging to be stored in the memory 14 so that the information can be referred to in subsequent processing (e.g., step S55 in FIG. 7).

The HDMI cable 22, which connects the sink device 11 and the source device 21, has multiple signal lines in addition to a signal line for transmitting the above-described HPD signal.

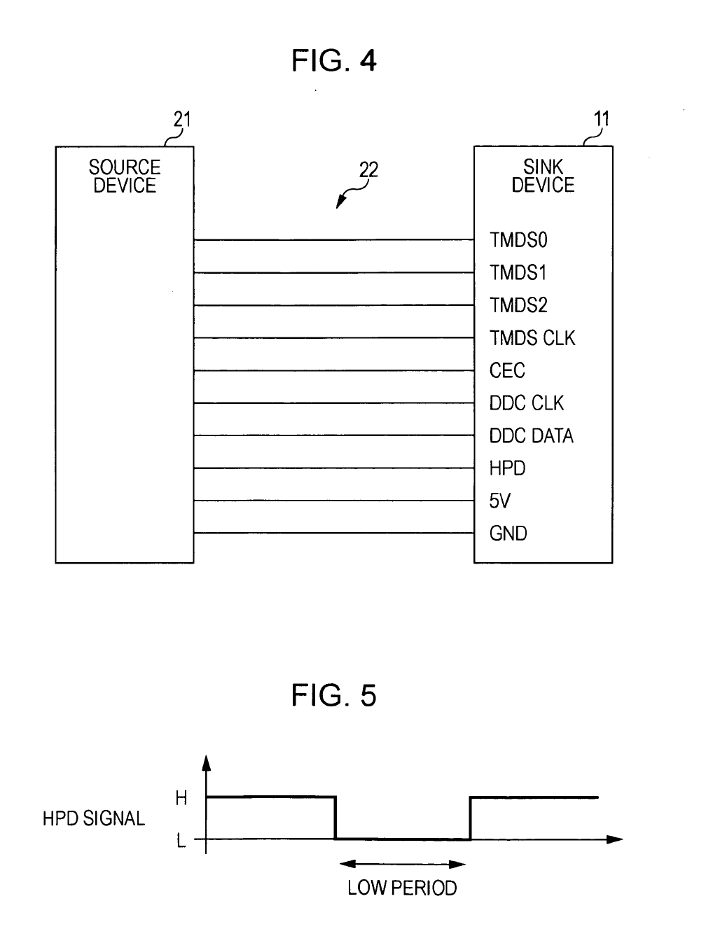

FIG. 4 is a diagram showing the configuration of the signal lines of the HDMI cable 22.

The HDMI cable 22 has signal lines TMDS0 to TMDS2, TMDS_CLK, CEC, DDC_CLK, DDC_DATA, and HPD, a power line 5V, and a ground line GND. The HDMI terminals of the sink device 11 and the source device 21 have connection terminals corresponding to the respective signal lines.

The signal lines TMDS0 to TMDS2 transmit TMDS signals that indicate data of content, the signal line TMDS_CLK transfers a clock signal that serves as a reference for processing the TMDS signals, and the signal line CEC transfers a control signal for mutually controlling the devices 11 and 21. The signal line DDC_DATA transfers a DDC (display data channel) signal indicating information of display characteristics and so on and the signal line DDC_CLK transfers a clock signal for the DDC signal. The signal line HPD transfers the HPD signal, and the power line 5V and the ground line GND are used to supply power with a voltage of 5 V.

During the input switching processing in which the source device 21 that is to input content to the sink device 11 is changed, the controller 15 controls the signal processor 13 to switch between outputs (high and low) of the HPD signal for the HDMI terminal.

FIG. 5 shows a change in the HPD signal for the HDMI terminal in the input switching processing, the HDMI terminal being selected by the user.

The controller 15 maintains the HPD signals for all HDMI terminals high so that EDID (extended display identification data) of the source devices 21 connected to the HDMI terminals 12(1) to 12(3) can be read anytime.

It is now assumed that the user operates an operation section (not shown) to select one of the HDMI terminals 12 as a terminal via which content is to be input. In response to the operation, the controller 15 controls the signal processor 13 to switch the HPD signal for the HDMI terminal 12, selected by the user, from high to low. The controller 15 reads the low period T_LOW stored in the memory 14 in association with the HDMI terminal 12, sets the HPD signal for the HDMI terminal 12 to low, and causes the processing to stand by until the low period T_LOW passes. Thereafter, when the low period T_LOW read from the memory 14 passes, the controller 15 controls the signal processor 13 to switch the HPD signal for the HDMI terminal 12 from low to high.

In the above-described processing, the HPD signal for the HDMI terminal 12 selected by the user is kept low for an amount of time corresponding to the low period T_LOW. That is, the signal processor 13 switches the HPD signal to be output to the source device 21, connected via the corresponding HDMI terminal 12, from high to low.

In this case, when the low period T_LOW is longer than a response time of the source device 21 connected to the HDMI terminal 12 selected by the user, i.e., is longer than the time from when the source device 21 detects that the HPD signal is switched to low until the source device 21 makes a response, the source device 21 perform resetting. After the resetting, the source device 21 transmits a data signal to the sink device 11.

The response times of the source devices 21 are different from each other. Accordingly, the sink device 11 performs low-period optimization processing, which optimizes the low period of the HPD signal, on the source device 21 connected to each of the HDMI terminal 12(1) to 12(3). The memory 14 stores the low periods, determined in the low-period optimization processing, in association with the corresponding HDMI terminals 12(1) to 12(3).

The low-period optimization processing is registered as, for example, one item for a menu screen that is to be displayed on a display (not shown) during various settings for the sink device 11. By operating the operation section to display the menu screen on the display, the user can give an instruction for executing the low-period optimization processing.

FIG. 6 is a flowchart illustrating the low-period optimization processing for optimizing the low period of the HPD signal.

When the user gives an instruction for executing the low-period optimization processing, the processing is started. In step S31, the controller 15 sets a setting value n for identifying the HDMI terminal 12 to 1, which is an initial value. The process then proceeds to step S32.

In step S32, the controller 15 initializes a tentative low period T1 of the HPD signal. The tentative low period is tentatively used in the low-period optimization processing. That is, the controller 15 sets the tentative low period T1 to the initial value t (init) of the low period of the HPD signal, for example, to 100 msec.

After the processing in step S32, the process proceeds to step S33 in which the controller 15 controls the signal processor 13 to switch the HPD signal (n) for the nth HDMI terminal 12(n) from high to low. The process then proceeds to step S34.

In step S34, the controller 15 causes the processing to stand by for an amount of time corresponding to the tentative low period T1 initialized in step S32 or corresponding to a tentative low period T1 updated in step S37 described below. Thereafter, when the tentative low period T1 passes after the HPD signal (n) is switched to low in step S33, the process proceeds to step S35.

In step S35, the controller 15 controls the signal processor 13 to switch the HPD signal (n) for the HDMI terminal 12(n) from low to high. That is, in the processing in steps S33 to S35, the HPD signal (n) for the HDMI terminal 12(n) is kept low for an amount of time corresponding to the tentative low period T1.

After the processing in step S35, the process proceeds to step S36. In step S36, the controller 15 determines whether or not a data signal is transmitted from the source device 21 as a result of setting (in steps S33 to S35) of the low state of the HPD signal (n) for the HDMI terminal 12 (n) for the amount of time corresponding to the low period T1 and thereby occurrence of resetting at the source device 21 connected to the HDMI terminal 12(n).

For example, the source device 21 transmits a data signal at predetermined intervals. When the controller 15 causes the processing to stand by for an amount of time corresponding to a system-dependent time T2 and the signal processor 13 receives the data signal and supplies the data signal to the controller 15 during the standby, the controller 15 determines that a data signal is transmitted from the source device 21. The time T2 is specified as a shortest possible period of time, considering hardware restrictions of the sink device 11 and a signal frequency. On the other hand, when no data signal is supplied from the signal processor 13 even when the processing stands by for an amount of time corresponding to the time T2, the controller 15 determines that no resetting occurs at the source device 21 and no data signal is transmitted from the source device 21.

In step S36, when the controller 15 determines that no data signal is transmitted from the source device 21, the process proceeds to step S37.

In step S37, the controller 15 sets, as a new tentative low period T1, a value obtained by adding a predetermined period α (e.g., 100 ms) to the tentative low period T1. That is, the controller 15 determines that the source device 21 cannot perform resetting in the current tentative low period T1, and thus updates the tentative low period T1 in order to obtain a shortest low period in which the source device 21 can make a response. Thereafter, the process returns to step S33 in which processing as described above is repeated until it is determined that a data signal is transmitted from the source device 21.

On the other hand, when the controller 15 determines in step S36 that a data signal is transmitted from the source device 21, the process proceeds to step S38. In step S38, the controller 15 causes the data signal, transmitted from the source device 21, to be stored in the memory 14.

After the processing in step S38, the process proceeds to step S39 in which the controller 15 causes the current tentative low period T1 to be stored, as the low period T_LOW(n) of the HPD signal (n) optimized for the source device 21 connected to the HDMI terminal 12(n), in the memory 14 in association with the HDMI terminal 12(n). That is, the current tentative low period T1 is determined to be a shortest low period in which the source 21 can make a response.

After the processing in step S39, the process proceeds to step S40 in which the controller 15 determines whether or not the setting value n for identifying the HDMI terminal 12 is equal to the number “N” of HDMI terminals (N=3 in the example in FIG. 2) included in the sink device 11. That is, the controller 15 determines whether or not all HDMI terminals included in the sink device 11 have been processed, i.e., whether or not the HDMI terminals 12(1) to 12(3) in the example in FIG. 2 have been processed.

When the controller 15 determines in step S40 that the setting value n is not equal to N, it means that there is an HDMI terminal that has not been processed, and the process proceeds to step S41. In step S41, the controller 15 increments the setting value n by 1. The process then returns to step S32 to perform processing on a next HDMI terminal. Thereafter, processing as described above is repeated.

On the other hand, when the controller 15 determines in step S40 that the setting value n is equal to N, all HDMI terminals included in the sink device 11 have been processed and thus the low-period optimization processing ends.

As described above, in the low-period optimization processing, the sink device 11 can determine, for each of the HDMI terminals 12(1) to 12(3), a shortest low period in which the source device 21 connected to each thereof can make a response. That is, the sink device 11 can optimize the low period for each source device 21.

Thus, in the input switching processing in which the source device 21 that is to input content to the sink device 11 is changed, it is possible to perform processing using the low period optimized for each of the HDMI terminals 12(1) to 12(3). The low-period optimization processing may be performed on only one of the HDMI terminals 12 which is specified by the user.

FIG. 7 is a flowchart illustrating the input switching processing in which the source device 21 that is to input content to the sink device 11 is changed.

For example, when the user operates the operation section (not shown) to specify the nth HDMI terminal 12(n) and to cause the source device 21 connected to the HDMI terminal 12(n) to input content to the sink device 11, the processing is started.

In step S51, the controller 15 controls the signal processor 13 so that the content is supplied to the HDMI terminal 12(n) that is specified by the user on the basis of a signal supplied from the operation section in accordance with the user operation. Under the control of the controller 15, the signal processor 13 performs switching so that data of the content input from the HDMI terminal 12(n) is supplied to a subsequent circuit (e.g., a decoding circuit or a display circuit). The controller 15 mutes outputting of the content (e.g., performs setting for causing a black image to be to be displayed on a display and for stopping outputting from a speaker).

After the processing in step S51, the process proceeds to step S52 in which the controller 15 controls the signal processor 13 to switch the HPD signal (n) for the HDMI terminal 12(n) from high to low. The process then proceeds to step S53.

In step S53, the controller 15 reads, from the memory 14, the low period T_LOW(n) stored in association with the HDMI terminal 12(n), i.e., the low period T_LOW(n) optimized for the source device 21 connected to the HDMI terminal 12 (n). The controller 15 then causes the processing to stand by from when the HPD signal for the HDMI terminal 12(n) is switched to low in step S52 until the low period T_LOW(n) passes. When the low period T_LOW(n) passes, the process proceeds to step S54.

In step S54, the controller 15 controls the signal processor 13 to switch the HPD signal (n) for the HDMI terminal 12(n) from low to high. That is, in the processing in steps S52 to S54, the HPD signal for the HDMI terminal 12(n) is kept low for an amount of time corresponding to the low period T_LOW(n) and a resetting request is issued to the source device connected to the HDMI terminal 12(n).

After the processing in step S54, the process proceeds to step S55 in which the controller 15 determines whether or not the HDMI cable 22 connected to the HDMI terminal 12(n) is still kept connected. As described above with reference to FIG. 3, when the HDMI cable 22 connected to the HDMI terminal 12(n) has ever been unplugged, information indicating the unplugging is stored in the memory 14 and the controller 15 performs determination on the basis of the information.

In step S55, when the controller 15 determines that the HDMI cable 22 connected to the HDMI terminal 12(n) is still kept connected, the process proceeds to step S56.

In step S56, the controller 15 determines whether or not setting has been performed so that the setting values stored in the memory 14 in association with the HDMI terminal 12(n) are to be used as setting values for outputting of content supplied from the source device 21 connected to the HDMI terminal 12(n) switched in step S51.

In this case, for example, an item for setting whether or not the setting values stored in the memory 14 are to be used on the menu screen for performing various settings is registered in the sink device 11. Thus, by operating the operation section, the user can set whether or not to use the setting values stored in the memory 14.

In step S56, when the controller 15 determines that setting has been performed so that the setting values stored in the memory 14 are to be used, the process proceeds to step S57. In step S57, the controller 15 reads the setting values from the memory 14 and performs setting for outputting of the content supplied from the source device 21 connected to the HDMI terminal 12(n).

After the processing in step S57, the process proceeds to step S58 in which the controller 15 releases the muting performed in step S51 and starts outputting of the content transmitted from the source device 21. That is, data of the content supplied from the source device 21 via the HDMI terminal 12(n) is supplied to the subsequent circuit, and in accordance with the data, video is displayed on the display and sound is output from the speaker.

In this case, since it was determined in step S55 that the HDMI cable 22 is kept connected, the controller 15 determines that the source device 21 connected to the HDMI terminal 12(n) is the same source device for which the setting values stored in the memory 14 were obtained. Thus, in step S57, the controller 15 performs setting based on the setting values read from the memory 14. However, even when it is determined that the HDMI cable 22 is kept connected, there is a possibility that the source device 21 connected to the HDMI terminal 12(n) is different from the source device 21 for which the setting values stored in the memory 14 were obtained. Accordingly, the controller 15 determines whether or not the setting for the outputting of the content is properly performed.

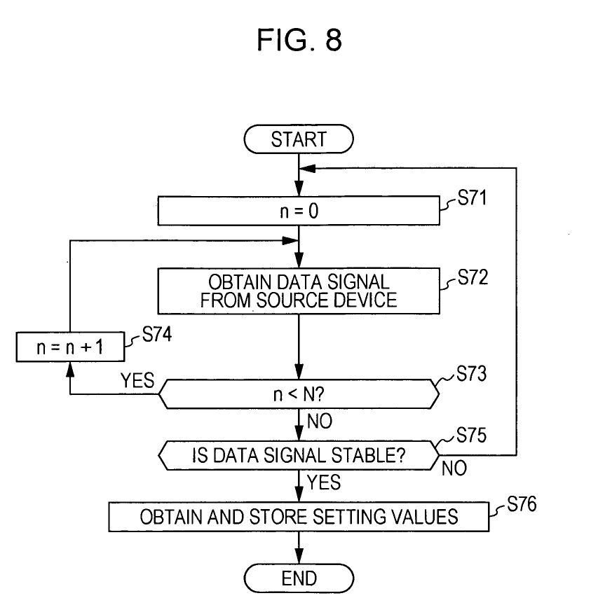

After the processing in step S58, the process proceeds to step S59 in which the controller 15 performs setting-value obtaining processing (described below and shown in FIG. 8) for obtaining setting values from the source device 21 connected to the HDMI terminal 12(n). The process then proceeds to step S60.

In step S60, the controller 15 determines whether or not there is a difference between the setting values obtained in the setting-value obtaining processing performed in step S59 and the corresponding setting values read from the memory 14 and used for the content-outputting setting performed in step S57.

When the controller 15 determines in step S60 that there is no difference between the setting values obtained in the setting-value obtaining processing performed in step S59 and the corresponding setting values read from the memory 14 and used for the content-outputting setting performed in S57, the input switching processing ends. On the other hand, when the controller 15 determines in step S60 that there is a difference between the setting values obtained in the setting-value obtaining processing performed in step S59 and the corresponding setting values read from the memory 14 and used for the content-outputting setting performed in S57, the process proceeds to step S61.

In step S61, the controller 15 stops the content outputting started in step S58, i.e., performs muting.

After the processing in step S61, the process proceeds to step S62. In step S62, the controller 15 resets the content-outputting setting performed in step S57. On the basis of the setting values obtained in the setting-value obtaining processing performed in step S59, the controller 15 performs content-outputting setting again.

After the processing in step S62, the process proceeds to step S63 in which the controller 15 releases the muting and starts outputting of the content, thereby ending the input switching processing.

On the other hand, when the controller 15 determines in step S55 that the HDMI cable 22 connected to the HDMI terminal 12(n) is not kept connected or when the controller determines in step S56 that no setting has been performed so that the setting values stored in the memory 14 are to be used, the process proceeds to step S64.

In step S64, the controller 15 performs setting-value obtaining processing (described below and shown in FIG. 8) for obtaining setting values from the source device 21 connected to the HDMI terminal 12(n), in the same manner as in step S59. The process then proceeds to step S65.

In step S65, the controller 15 performs setting for outputting of the content, on the basis of the setting values obtained in the setting-value obtaining processing performed in step S64. In step S66, the controller 15 releases the muting and starts outputting of the content, thereby ending the input switching processing.

As described above, the sink device 11 can perform setting based on the setting values stored in the memory 14, so that the amount of time taken until outputting of the content is stared can be reduced.

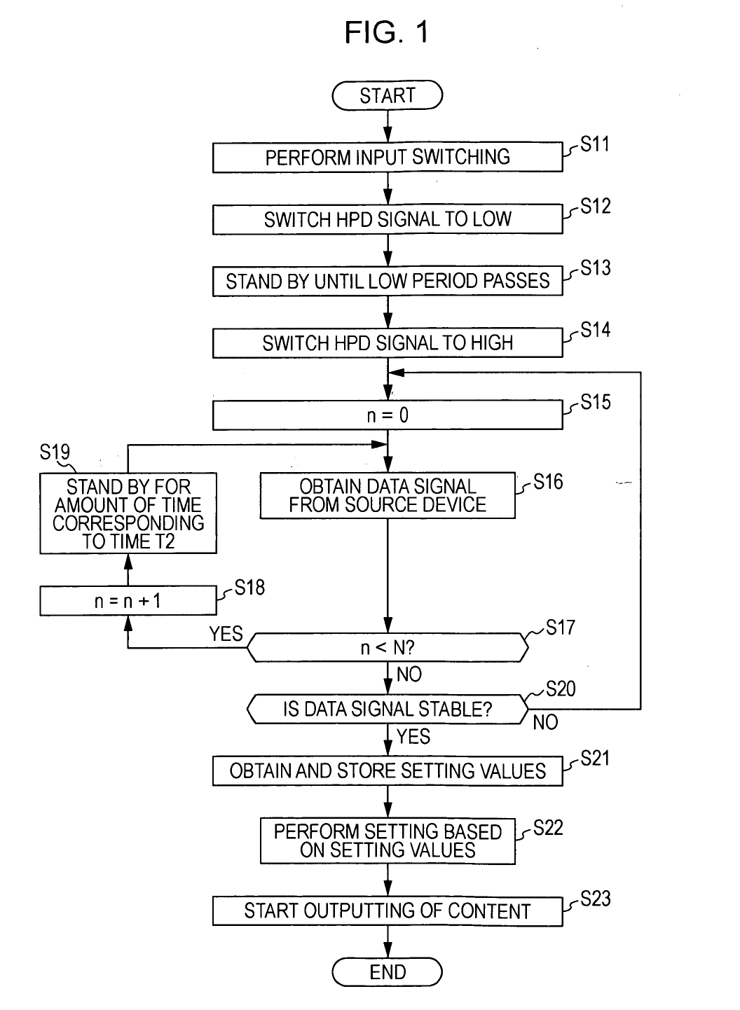

That is, as described above with reference to FIG. 1, the sink device of the related art causes the processing to stand by until the data signal transmitted from the source device becomes stable and then performs setting based on the setting values obtained from the data signal. Consequently, a large amount of time is taken from when the user performs an input-switching operation until outputting of content is started.

In contrast, the sink device 11 according to the embodiment of the present invention can perform setting based on the setting values stored in the memory 14. Thus, compared to the sink device of the related art, the sink device 11 according to the embodiment can reduce the amount of time from when the user performs an input-switching operation until outputting of content is started.

In addition, in the input switching processing, the sink device 11 stands by for an amount of time corresponding to the optimized low period determined in the low-period optimization processing, by switching the HPD signal to low. Thus, it is possible to improve the operability, compared to the sink device of the related art.

That is, in general, design of a sink device is performed on the assumption that what type of source device is to be connected thereto is unknown during the design. Thus, it has been generally required to perform adjustment to, of source devices connected to the sink device, a source device having a worst condition for the sink device. For example, even when a source device whose response to a control signal from the sink device is slow is connected, it is generally necessary to design the sink device so that it can appropriately deal with the response from the source device.

As described above, the HDMI standard states that, when the sink device issues a resetting request to the source device, control is performed so as to switch between the high and the low of the HPD signal at predetermined control timing. However, when control for the switching of the HPD signal is performed so as to barely comply with the standard, the resetting may not work properly depending on the source device. Thus, the sink device controls the HPD signal by performing adjustment to, of source devices that have ever been connected, a source device having a worst condition (a source device that takes a largest amount of time).

However, performing control of the HPD signal by performing adjustment to the source device having a worst condition means giving excessive redundancy, resulting in a reduction in the operability.

In contrast, the sink device 11 optimizes the low period for each source device 21 and uses the low period determined for each source device 21, which thus does not involve an excessive amount time for causing the processing to stand by. Thus, in accordance with the response time of the source device 21, the sink device 11 can output content with an appropriate standby time. Thus, the sink device 11 can reduce the user's waiting time and can quickly respond to an operation. That is, it is possible to improve the operability of the sink device 11.

Even when any source device 21 is connected, for example, even when the source device 21 having a long response time is connected, the sink device 11 can reliably control the source device 21, since the low period in which the source device 21 can make a response is determined in the low-period optimization processing.

In addition, the sink device 11 detects plugging/unplugging of the HDMI cable 22, and when the possibility that the source device 21 is to be changed is high after the HDMI cable 22 is unplugged, the sink device 11 performs resetting (in step S62) based on the setting values obtained from the data signal transmitted from the currently connected source device 21. Thus, even when the source device 21 is changed, the sink device 11 can properly perform content-outputting setting and can prevent image-quality and sound-quality declines, such as image distortion and sound interruption.

FIG. 8 is a flowchart illustrating the setting-value obtaining processing in step S59 or S64 shown in FIG. 7.

In step S71, the controller 15 sets the parameter n to 0, which is the initial value, and the process proceeds to step S72.

In step S72, the controller 15 obtains the data signal, which is periodically transmitted from the source device 21, via the HDMI terminal 12.

After the processing in step S72, the process proceeds to step S73 in which the controller 15 determines whether or not the parameter n is smaller than N, which is preset as the number of operations for obtaining the data signal transmitted from the source device 21.

When the controller 15 determines in step S73 that the parameter n is smaller than N, the process proceeds to step S74 in which the controller 15 increments the parameter n by 1. The process then returns to step S72. That is, the processing is repeated until it is determined in step S73 that the parameter n is not smaller than N (i.e., is equal to N), that is, until the data signal is received N times.

On the other hand, when the controller 15 determines in step S73 that the parameter n is not smaller than N, the process proceeds to step S75 in which the controller 15 determines whether or not the data signal transmitted from the source device 21 is stable. For example, when all the data signals received through the N obtaining operations have the same contents, the controller 15 determines that the data signal transmitted from the source device 21 is stable, and when the contents of even one of the data signals received through the N obtaining operations is different from the contents of another data signal, the controller 15 determines that the data signal is not stable.

When the controller 15 determines in step S75 that the data signal transmitted from the source device 21 is not stable, the process returns to step S71 and then processing as described above is repeated until it is determined that data signal transmitted from the source device 21 is stable. On the other hand, when the controller 15 determines in step S75 that the data signal transmitted from the source device 21 is stable, the process proceeds to step S76.

In step S76, the controller 15 obtains the setting values of, for example, the resolution information, color-space information, and sound information from the data signal, and stores the setting values in the memory 14, thereby ending the setting-value obtaining processing.

By pre-checking timing at which the data signal is transmitted from the source device 21, the sink device 11 can optimize timing for releasing the muting.

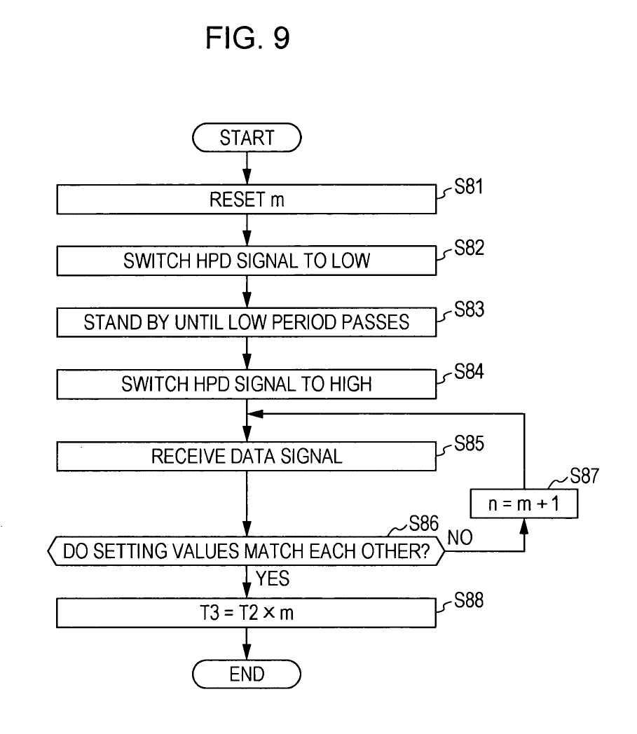

FIG. 9 is a flowchart illustrating release optimization processing for optimizing the timing for releasing the muting.

For example, when the low period optimized for each HDMI terminal 12 is determined in the low-period optimization processing in FIG. 6, the release optimization processing is performed on the HDMI terminal 12. For example, the release optimization processing may be performed on an arbitrary one of the HDMI terminals 12 in accordance with a user operation.

In step S81, the controller 15 resets a parameter m, for example, sets a parameter m to 1, which is an initial value. The process then proceeds to step S82.

In step S82, the controller 15 controls the signal processor 13 to switch the HPD signal for the HDMI terminal 12 from high to low. The process then proceeds to step S83.

In step S83, the controller 15 causes the processing to stand by for an amount of time corresponding to the low period optimized for the HDMI terminal 12 to be processed, the low period being determined in the low-period optimization processing. In step S82, the controller 15 switches the HPD signal to low. When the optimized low period passes, the process proceeds to step S84.

In step S84, the controller 15 controls the signal processor 13 to switch the HPD signal for the HDMI terminal 12 from low to high. That is, in the processing in steps S82 to S84, the HPD signal for the HDMI terminal 12 is kept low for an amount of time corresponding to the low period optimized for the source device 21 connected to the HDMI terminal 12.

After the processing in step S84, the process proceeds to step S85 in which the controller 15 receives the data signal transmitted, as a result of the low state of the HPD signal for the amount of time corresponding to the low period, from the source device 21, connected to the HDMI terminal 12, via the signal processor 13. The process then proceeds to step S86.

In step S86, the controller 15 determines whether or not the setting values (e.g., the setting values obtained in the low-period optimization processing) stored in the memory 14 in association with the HDMI terminal 12 to be processed and the corresponding setting values obtained from the data signal received in step S85 match each other.

When the controller 15 determines in step S86 that the setting values do not match each other, the process proceeds to step S87 in which the controller 15 increments the parameter m by 1. The process then returns to step S85 and processing as described above is repeated.

On the other hand, when the controller 15 determines in step S86 that the setting values match each other, the process proceeds to step S88. In step S88, the controller 15 specifies, as a time T3 for muting, a value obtaining by multiplying the above-described time T2 by the parameter m, thereby ending the release optimization processing.

In this case, the value obtained by multiplying the time T2 by the parameter m becomes a time from when the HPD signal for the HDMI terminal 12 is switched from low to high in step S84 until it is determined that the setting values match each other. That is, the time taken until it is determined that the setting values match each other is regarded as a so-called “transient state” in which video or sound data may be interrupted, and the controller 15 sets the time as the time T3 for muting.

For example, in the input switching processing shown in FIG. 7, the time T3 for muting is a time from when the HPD signal for the HDMI terminal 12(n) is switched from low to high (in step S54) until outputting of the content is started (in step S58). Optimization of the time T3 for muting, as described above, makes it possible to prevent the sink device 11 from outputting video and sound in an interrupted manner and also makes it possible to improve the qualities. This arrangement can also eliminate necessity for setting an excessively large amount of muting time which gives redundancy.

In addition, determining the time T3 for muting for each HDMI terminal 12 and storing the determined time T3 in the memory 14 makes it possible to perform muting on the source device 21, connected to the HDMI terminal 12, for an adequate amount of time.

As described above, optimizing the low period, performing setting using the setting values stored in the memory 14, and optimizing the time for muting makes it possible to quickly and reliably perform setting for the sink device 11 compared to the related art.

For example, the sink device 11 may transmit a POWER_ON command based on a CEC command to the source device 21 to start up the source device 21 to thereby transmit a data signal, so that the sink device 11 obtains the setting values.

The controller 15 can execute not only a program pre-stored in the memory 14 or the like but also a program downloaded and installed (updated) to the memory 14 via a communication device (not shown). Thus, the low-period optimization processing, the input switching processing, and the release optimization processing can be realized by updating the program to be executed by the controller 15, without use of special hardware.

In the sink device 11, the controller 15 can not only perform an operation on a signal output from each of the HDMI terminals 12(1) to 12(3) by using the signal processor 13 and also can directly perform an operation on a signal.

The series of the processing described above with reference to the flowcharts do not necessarily have to be time-sequentially performed in accordance with the sequences illustrated in the flowcharts, and also include processing executed in parallel or individually (e.g., parallel processing or object-based processing). The program may be processed by one CPU or may be processed in a distributed manner by multiple CPUs.

The present invention is not limited to the above-described embodiments, and various changes can be made thereto without departing from the spirit and scope of the present invention.

It should be understood by those skilled in the art that various modifications, combinations, sub-combinations and alterations may occur depending on design requirements and other factors insofar as they are within the scope of the appended claims or the equivalents thereof.

What is claimed is:

1. A content outputting device comprising:
connecting means used for connection with another device;
storing means for storing, in association with the connecting means, a setting value used for setting for outputting of content to be supplied from the another device connected via the connecting means; and
setting means for performing, during start of the outputting of the content supplied from the another device, the setting for the outputting of the content, on a basis of the setting value stored by the storing means.

2. The content outputting device according to claim 1, further comprising:
obtaining means for obtaining the setting value from the another device when the connection with the another device is not maintained,
wherein the setting means resets the setting value stored by the storing means and performs the setting for the outputting of the content on a basis of a new setting value obtained by the obtaining means.

3. The content outputting device according to claim 1, further comprising:
signal controlling means for making, for a predetermined period of time, a change to a control signal output to the another device via the connecting means;
determining means for determining whether or not the another device responds to the change made to the control signal by the signal controlling means for the predetermined period of time; and
specifying means for specifying, as a standby time for the another device connected via the connecting means, the predetermined period of time that is determined by the determining means to be a shortest period time in which the another device responds to the change in the control signal.

4. The content outputting device according to claim 1, further comprising:
signal controlling means for making, for a predetermined period of time, a change to a control signal output to the another device via the connecting means;
setting-value obtaining means for obtaining a setting value from a signal, the signal being transmitted from the another device in response to the change in the control signal for the predetermined period of time, the change being made by the signal controlling means; and
timing determining means for measuring a time taken until the setting value obtained by the setting-value obtaining means matches the setting value stored by the storing means and for determining timing for releasing muting of the content.

5. A content outputting method for a content outputting device for outputting content, the content outputting device having connecting means used for connection with another device and storing means for storing, in association with the connecting means, a setting value used for setting for outputting of content to be supplied from the another device connected via the connecting means, the content outputting method comprising a step of:
causing the content outputting device to perform, during start of the outputting of the content supplied from the another device connected via the connecting means, the setting for the outputting of the content, on a basis of the setting value stored by the storing means.

6. A program for a computer for a content outputting device for outputting content, the content outputting device having connecting means used for connection with another device and storing means for storing, in association with the connecting means, a setting value used for setting for outputting of content to be supplied from the another device connected via the connecting means, the program causing the computer to function as:
setting means for performing, during start of the outputting of the content supplied from the another device connected via the connecting means, the setting for the outputting of the content, on a basis of the setting value stored by the storing means.

7. A content outputting device comprising:
a connecting section used for connection with another device;
a storing section configured to store, in association with the connecting section, a setting value used for setting for outputting of content to be supplied from the another device connected via the connecting section; and
a setting section configured to perform, during start of the outputting of the content supplied from the another device, the setting for the outputting of the content, on a basis of the setting value stored by the storing section.

8. The content outputting device according to claim 7, further comprising:
an obtaining section configured to obtain the setting value from the another device when the connection with the another device is not maintained,
wherein the setting section resets the setting value stored by the storing section and performs the setting for the outputting of the content on a basis of a new setting value obtained by the obtaining section.

9. The content outputting device according to claim 7, further comprising:
a signal controlling section configured to make, for a predetermined period of time, a change to a control signal output to the another device via the connecting section;
a determining section configured to determine whether or not the another device responds to the change made to the control signal by the signal controlling section for the predetermined period of time; and
a specifying section configured to specify, as a standby time for the another device connected via the connecting section, the predetermined period of time that is determined by the determining section to be a shortest period time in which the another device responds to the change in the control signal.

10. The content outputting device according to claim 7, further comprising:
a signal controlling section configured to make, for a predetermined period of time, a change to a control signal output to the another device via the connecting section;
a setting-value obtaining section configured to obtain a setting value from a signal, the signal being transmitted from the another device in response to the change in the control signal for the predetermined period of time, the change being made by the signal controlling section; and
a timing determining section configured to measure a time taken until the setting value obtained by the setting-value obtaining section matches the setting value stored by the storing section and for determining timing for releasing muting of the content.

11. A content outputting method for a content outputting device for outputting content, the content outputting device having a connecting section used for connection with another device and a storing section for storing, in association with the connecting section, a setting value used for setting for outputting of content to be supplied from the another device connected via the connecting section, the content outputting method comprising a step of:
causing the content outputting device to perform, during start of the outputting of the content supplied from the another device connected via the connecting section, the setting for the outputting of the content, on a basis of the setting value stored by the storing section.

12. A program for a computer for a content outputting device for outputting content, the content outputting device having a connecting section used for connection with another device and a storing section configured to store, in association with the connecting section, a setting value used for setting for outputting of content to be supplied from the another device connected via the connecting section, the program causing the computer to function as:
a setting section configured to perform, during start of the outputting of the content supplied from the another device connected via the connecting section, the setting for the outputting of the content, on a basis of the setting value stored by the storing section.
